(19) United States
(12) Patent Application Publication
(10) Pub. No.: US 2004/0028452 A1
(43) Pub. Date: Feb. 12, 2004

(54) Adhesive stick

(76) Inventor: Peter Koreska, Vienna (AT)

Correspondence Address: PILLSBURY WINTHROP, LLP, P.O. BOX 10500, MCLEAN, VA, 22102, US

(21) Appl. No.: 10/380,333

(22) PCT Filed: Sep. 17, 2001
(86) PCT No.: PCT/AT01/00295

(30) Foreign Application Priority Data
Sep. 20, 2000 (AT) GB 169/2000

(51) Int. Cl. B43K 21/08

(52) U.S. Cl. 401/72

(57) ABSTRACT

An adhesive stick (1) for applying an adhesive, comprising a cylindrical housing (2) containing a spindle drive (5) for an elongate body of adhesive for axial displacement of the latter, a twist grip (4) being provided at one end of the housing (2) and connected to the spindle drive (5), wherein on the cylindrical housing (2), following the twist grip (4), a sleeve (7) is rotatably mounted on the outside, which sleeve is designed to be at least partially transparent or perforated for looking therethrough onto the housing (2) which is provided with an imprint.

The invention relates to an adhesive stick for applying adhesive and comprising a cylindrical housing including a spindle drive for an elongate body of adhesive for axial displacement of the latter, a twist grip being provided at one end of the housing and connected to the spindle drive.

Such adhesive sticks are known e.g. from WO 95/28857, DE 9209241 U and numerous other publications. The body of adhesive is particularly suitable for gluing paper. Because it is very user friendly, making soiling outside the site of adhesion, e.g. on account of late dripping or the like nearly impossible, such adhesive sticks are very popular, particularly among children. Optically, however, such adhesive sticks are hardly attractive for children, and, moreover, a large area of the adhesive stick, i.e. the jacket face of the housing, remains unused.

From U.S. Pat. No. 5,525,383 A a drinking cup is known which has a translucent or transparent outer sheath to make it optically more attractive. In this instance, the moiré effect is utilized with which, in a strip-shaped image which is covered by a film having transparent strips of the same width as the image, a cinematographic effect is produced when rotating the film.

It is an object of the invention to provide an adhesive stick of the initially defined type which, in addition to the high convenience for users, has a further feature particularly for children which makes the adhesive sticks even more attractive for children. The jacket face of the housing, which in known adhesive sticks so far has remained completely unused, is particularly suitable for this.

The inventive adhesive stick of the initially defined type is characterized in that on the cylindrical housing, following the twist grip, a sleeve is rotatably mounted on the outside, which sleeve is designed to be at least partially transparent or perforated for looking therethrough onto the housing which is provided with an imprint.

In this manner, the most varying optical attractions for users who primarily will be children can be produced, and thus the adhesive sticks can be made more attractive.

For a particularly simple construction in which the sleeve will automatically co-rotate when the twist grip is rotated, it is suitable if the twist grip is integrally connected with the sleeve.

Likewise, it is possible in a simple manner to corotate the sleeve with the twist grip if advantageously the sleeve is connected to the twist grip with a positive fit.

Automatic co-rotation of the sleeve with the twist grip can also be achieved if the sleeve is simply connected to the twist grip by a friction fit.

If the housing has a conical shape, slightly widening from the twist grip, the sleeve will be at least in one direction axially secured and thus can no longer slip off from the housing in this direction.

For axially securing in the direction of the twist grip, it is advantageous if the twist grip has a radial cross-sectional enlargement on its surface, at its end region facing the housing, for an abutment on the sleeve.

To obtain material-saving stops for the sleeve, it is suitable if knobs are provided as cross-sectional enlargement.

For a full stop projection by which the sleeve will be axially secured in the direction of the twist grip, it is advantageous if a bead is provided as the cross-sectional enlargement.

Axially securing the sleeve in the direction of the twist grip can also be obtained in a structurally simple manner if a ring, or a ring disk, respectively, is provided between the twist grip and the housing, which ring or ring disk has an outer diameter that corresponds at least to the diameter of the sleeve.

If the housing comprises a bead in both end regions which bead engages in a respective flute in the sleeve so as to axially secure it, the sleeve can be radially rotated, yet not slip in axial direction.

To make it possible for the user to obtain better optic effects, it is advantageous if the partially transparent or perforated regions of the sleeve in one or more see-through positions are in relation with the imprint provided on the housing.

For a particularly attractive embodiment, especially for children who will use the adhesive stick e.g. in school, it is advantageous if as said imprint a matrix is provided on the housing which in the first line, or column thereof, respectively, comprises the numbers 1 to 10, or 11 to 20, respectively, and on the remaining matrix sites shows the result of the multiplication of the number of the respective first line with that of the respective first column, the sleeve having transparent or perforated areas allowing to see therethrough onto one number each in the first line and one in the first column, as well as the result of a multiplication thereof.

If, for producing a moiré effect, the imprint on the housing is at least in areas thereof screened in strips, and the sleeve comprises at least partially transparent strips of a width corresponding to the width of the screen strips of the imprint on the housing, a cinematographic effect can advantageously be obtained which will make the adhesive pin particularly attractive to children.

In the following, the invention will be explained in more detail by way of preferred exemplary embodiments illustrated in the drawings to which, however, it shall not be restricted. In detail, in the drawings,

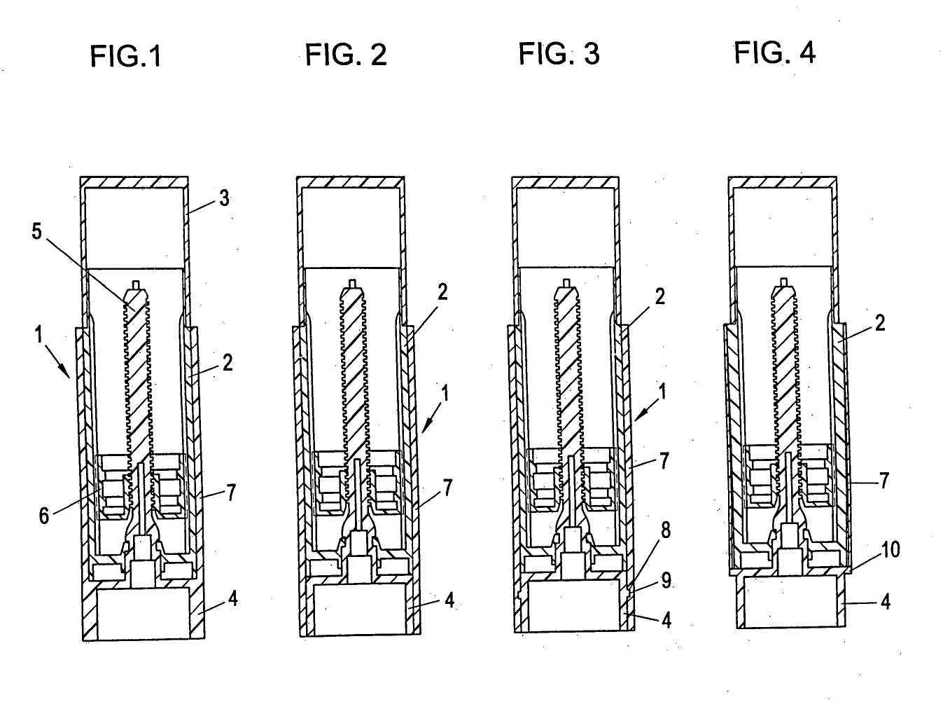

FIG. 1 shows a longitudinal section of an adhesive stick with a sleeve integrally connected to the grip;

FIG. 2 shows a longitudinal section through an adhesive stick with a sleeve frictionally engaged on the grip;

FIG. 3 shows a longitudinal section of an adhesive stick comprising a sleeve positively connected to the grip;

FIG. 4 shows a longitudinal section of an adhesive stick having a slightly conically shaped housing and a twist grip with knobs;

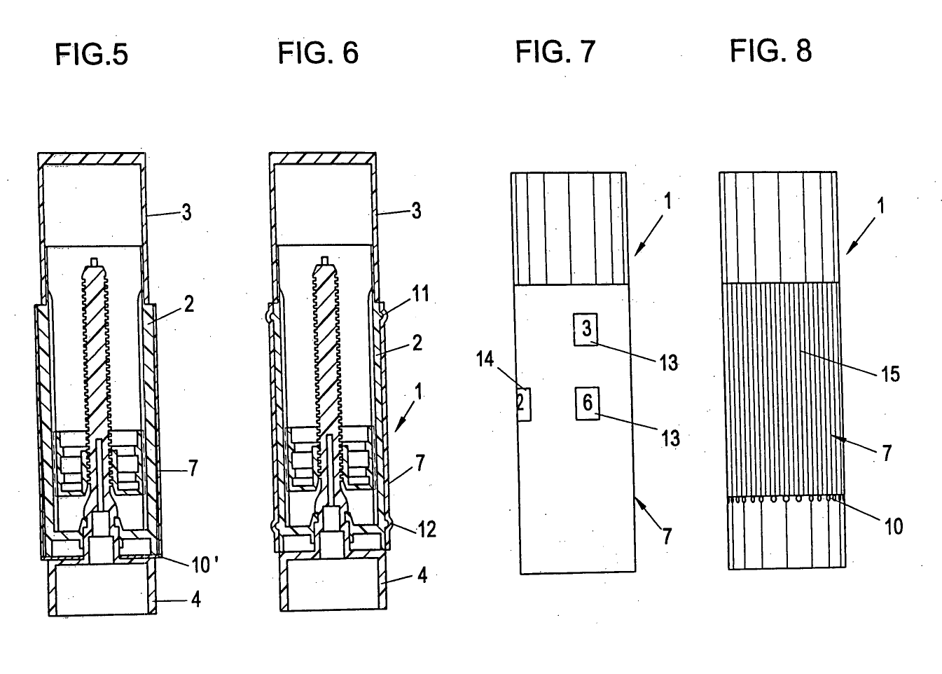

FIG. 5 shows an adhesive stick similar to FIG. 4 comprising an annular disk between the housing and the twist grip;

FIG. 6 shows a longitudinal section of an adhesive stick comprising a sleeve rotatably mounted on the housing via two beads;

FIG. 7 shows a front view of an adhesive stick with an indication of the multiplication table up to ten; and

FIG. 8 shows a front view of an adhesive stick with a screened, partially transparent sleeve for producing a moiré effect.

FIG. 1 shows an adhesive stick 1 with a cylindrical housing 2 on which a cover cap 3 is provided. A twist grip 4 is provided at the lower end of housing 2 and connected to a spindle drive 5 for axial displacement of a cylindrical body of adhesive (not illustrated) fixed in a mount 6. The mount 6 is secured against rotation in the interior of housing 2 and is in threaded engagement with the spindle drive 5 in the manner of a spindle nut so that the body of adhesive will be axially displaced when the twist grip 4 is rotated.

In the exemplary embodiment illustrated in FIG. 1, a sleeve 7 is integrally connected to the twist grip 4. The sleeve 7 comprises at least partially transparent or perforated areas 13 (cf. FIG. 7) for looking therethrough onto housing 2. On housing 2 an imprint 14 (cf. FIG. 7) is provided which can be brought in relation with the transparent, or perforated areas, respectively, by rotating the twist grip 4.

In FIG. 2, also an adhesive stick 1 with a sleeve 7 surrounding the cylindrical housing 2 is shown. In the exemplary embodiment illustrated in FIG. 2, the sleeve 7 is connected to the twist grip 4 by a positive locking connection, i.e. the outer periphery of the twist grip 4 and the inner diameter of sleeve 7 are connected by means of a press fit. On the other hand, there exists a slight play between the outer diameter of housing 2 and the inner diameter of sleeve 7, whereby in turn sleeve 7 can be brought into different positions relative to the housing 2 when the twist grip 4 is rotated, and thus transparent, or perforated areas, respectively, of the sleeve 7 can be put into relation to an imprint on the outer side of sleeve 2.

FIG. 3 in turn shows an adhesive stick 1 on whose cylindrical housing 2 a sleeve 7 is provided. Here, the connection between sleeve 7 and twist grip 4 is effected via radial projections on the jacket face of the twist grip 4 which engage in depressions 9 of sleeve 7, thereby providing a positive locking connection between sleeve 7 and twist grip 4. Thus, in turn, sleeve 7 will co-rotate with twist grip 4 when twist grip 4 is rotated relative to the stationary housing 2, and sleeve 7 thus can be adjusted relative to the housing 2 by rotating the twist grip 4.

In FIG. 4, an adhesive stick 1 is shown which has a housing 2 that has a substantially cylindrical shape, the outer diameter of the housing 2 slightly widening towards the cover cap 3, whereby a slightly conical shape is created. By the conical design of the outer side of housing 2, the cylindrical sleeve 7, in that end of housing 2 which faces the cover cap 3, will comparatively tightly contact housing 2 so that according to the illustration of FIG. 4, it cannot slip off the housing 2 in upward direction. To axially secure sleeve 2 on adhesive stick 1 against a slipping off in downward direction, twist grip 4 comprises radially projecting knobs 10 (cf. also FIG. 8) at its end region facing housing 2, the sleeve 7 abutting on these knobs 10. In the exemplary embodiment illustrated in FIG. 4, therefore, sleeve 7 does not co-rotate when twist grip 4 is rotated and will remain n a resting position relative to housing 2 when the twist grip 4 is rotated. However, sleeve 7 may easily be rotated relative to housing 2 by applying a torque that overcomes the frictional engagement at the upper end of housing 2. In this manner, transparent, or perforated areas, respectively, of sleeve 7 can be adjusted relative to an imprint provided on housing 2, independently of the position of twist grip 4.

In FIG. 5, an adhesive stick 1 similar to adhesive stick 1 according to FIG. 4 is shown, in which sleeve 7 is held upwardly also by the conical shape of housing 2; however, to prevent slipping off of sleeve 7 in the direction of twist grip 4, an annular disk 10′ is provided between twist grip 4 and housing 2. The annular disk 10′ has a somewhat wider outer diameter than sleeve 7, whereby the latter is reliably secured in longitudinal direction on housing 2.

FIG. 6 shows an adhesive stick 1 in which a sleeve 7 is rotatably mounted on housing 2 by means of annular flutes 12. The annular flutes 12 which are provided in the upper end region facing cover cap 3 and in the lower end region facing twist grip 4 each co-operate with a bead 11 provided on the outer face of housing 2, which bead engages in said flutes. Thus, sleeve 7 is axially secured on housing 2, yet the sleeve 7 can be rotated relative to housing 2. However, such rotation will occur independently of a rotation of twist grip 4.

FIG. 7 shows a view of an adhesive stick 1 in which sleeve 7 is integrally connected with grip 4 and comprises perforated areas 13 on the outer face of housing 2, an imprint 14 is provided which forms a matrix, wherein the first line, or the first column, respectively, of the matrix comprises the numbers “1” to “10” (or “11” to “20”), and the remaining matrix sites contain the result of the multiplication of the respective numbers in the first line and first column, respectively. By rotating sleeve 7, the perforated areas 13 may be rotated relative to housing 2 such that in each case a first site of the first line, or a site of the first column, respectively, of the matrix provided on the housing will be visible, as well as the result of the multiplication of these two numbers.

In FIG. 8, an adhesive stick 1 is shown which has a sleeve 7 with transparent strips 15. Sleeve 7 is axially secured by the conical shape of housing 2, below radially projecting knobs 10 on twist grip 4. On a housing 2, an imprint is provided which is screened in strips, these strips having the same width as those of the transparent strips 15 of sleeve 7. In this manner, by rotating sleeve 7 on housing 2, a cinematographic effect also known as moiré effect can be produced.

1. An adhesive stick (1) for applying an adhesive, comprising a cylindrical housing (2) containing a spindle drive (5) for an elongate body of adhesive for axial displacement of the latter, a twist grip (4) being provided at one end of the housing (2) and connected to the spindle drive (5), characterized in that on the cylindrical housing (2), following the twist grip (4), a sleeve (7) is rotatably mounted on the outside, which sleeve is designed to be at least partially transparent or perforated for looking therethrough onto the housing (2) which is provided with an imprint (14).

2. An adhesive stick according to claim 1, characterized in that the sleeve (7) is integrally connected to the twist grip (4).

3. An adhesive stick according to claim 1, characterized in that the sleeve (7) is positively connected to the twist grip (4).

4. An adhesive stick according to claim 1, characterized in that the sleeve (7) is connected to the twist grip (4) by frictional engagement.

5. An adhesive stick according to claim 1, characterized in that the housing (2) has a conical shape slightly widening from the twist grip (4) onwards.

6. An adhesive stick according to claim 1 or 5, characterized in that the twist grip (4) at its surface in its end region facing the housing (2) has a radial cross-sectional enlargement (10) for abutment of the sleeve.

7. An adhesive stick according to claim 1 or 5, characterized in that knobs are provided as said cross-sectional enlargement (10).

8. An adhesive stick according to claim 1 or 5, characterized in that a bead is provided as said cross-sectional enlargement (10).

9. An adhesive stick according to claim 1 or 5, characterized in that an annular disk (10′) is provided between the twist grip (4) and the housing (2), the outer diameter of said annular disk at least corresponding to the diameter of the sleeve (7).

10. An adhesive stick according to claim 1, characterized in that the housing (2) has a bead (11) in both end regions, which bead engages in an associated flute (12) in the sleeve (7) for axially securing the latter.

11. An adhesive stick according to any one of claims 1 to 10, characterized in that the partially transparent or perforated areas (13, 15) of the sleeve (7) in one or more see-through positions are in relation with the imprint (14) provided on the housing (2).

12. An adhesive stick according to any one of claims 1 to 11, characterized in that a matrix is provided as said imprint (14) on the housing (2), which matrix in the first line, or column thereof, respectively, comprises the numbers “1” to “10”, or “11” to “20”, respectively, and on the remaining matrix sites exhibits the result of the multiplication of the number of the respective first line with that of the respective first column, the sleeve having transparent or perforated sites (13) allowing to see therethrough onto one number each in the first line and one in the first column, as well as the result of the multiplication thereof.

13. An adhesive stick according to any one of claims 1 to 11, characterized in that the imprint (14) on the housing (2) is at least in areas thereof screened in strips for producing a moiré effect, and the sleeve (7) comprises at least partially transparent strips (15) of a width corresponding to the width of the screen strips of the imprint (14) on the housing (2).
